(19) United States
(12) Patent Application Publication
(10) Pub. No.: US 2010/0273946 A1
(43) Pub. Date: Oct. 28, 2010

(54) MICROCAPSULE, METHOD FOR MAKING THE SAME, AND COMPOSITE USING THE SAME

(75) Inventors: HUI-LING ZHANG, Beijing (CN); YUAN YAO, Beijing (CN); JI-CUN WANG, Beijing (CN); YOU-SEN WANG, Beijing (CN); FENG-WEI DAI, Beijing (CN)

Correspondence Address: Altis Law Group, Inc.;ATTN: Steven Reiss, 288 SOUTH MAYO AVENUE, CITY OF INDUSTRY, CA, 91789, US

(73) Assignees: TSINGHUA UNIVERSITY, Beijing (CN); HON HAI PRECISION INDUSTRY CO., LTD., Tu-Cheng (TW)

(21) Appl. No.: 12/564,850

(22) Filed: Sep. 22, 2009

(30) Foreign Application Priority Data
Apr. 24, 2009 (CN) 200910107148.4

(51) Int. Cl. C08F 8/00; C08G 18/00

(52) U.S. Cl. 525/123; 525/452

(57) ABSTRACT

A carbon nanotube microcapsule includes at least one carbon nanotube and a shell encapsulating the at least one carbon nanotube. The shell includes a plurality of first functional groups. A composite using the carbon nanotube microcapsule, and a method for making the carbon nanotube microcapsule is also disclosed.

### BACKGROUND

1. Technical Field

The present disclosure relates to microcapsules, and methods for making the same and, particularly, to a carbon nanotube microcapsule, a method for making the microcapsule, and a composite using the microcapsule.

2. Description of Related Art

Carbon nanotubes are a novel carbonaceous material having an extremely small size and an extremely large specific surface area. Carbon nanotubes have received a great deal of interest since the early 1990s, because of interesting and potentially useful electrical and mechanical properties, and have been widely used in a plurality of fields. The addition of carbon nanotubes into other materials such as polymers and fibers are proposed to enhance the mechanical properties of the other materials. For example, carbon nanotubes can be grafted directly onto a carbon fiber to achieve a composite having enhanced mechanical properties.

However, carbon nanotubes have an inactive surface that is difficult to combine with other materials. To solve this problem, a conventional method is sidewall covalent functionalization of the carbon nanotubes which forms a plurality of active functional groups on the sidewall of the carbon nanotubes. During sidewall covalent functionalization, the carbon nanotubes are treated with strong acids to break the carbon-carbon bonds of the sidewall. The disadvantage of this approach is that intrinsic properties of the carbon nanotubes are changed significantly.

What is needed, therefore, is to provide a carbon nanotube microcapsule that functionalizes the carbon nanotubes and preserves the intrinsic properties of the carbon nanotubes, a method for making the same, and a composite using the same.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout several views.

FIG. 1 is a schematic structural view of one embodiment of a carbon nanotube microcapsule-carbon fiber based composite.

FIG. 2 is a cross sectional view of the carbon nanotube microcapsule of FIG. 1 having a single carbon nanotube.

FIG. 3 is a cross sectional view of the carbon nanotube microcapsule of FIG. 1 having several crossed carbon nanotubes.

FIG. 4 is a flow chart of one embodiment of a method for making the carbon nanotube microcapsule.

FIG. 5 is a flow chart of one embodiment of a method for making the carbon nanotube microcapsule-carbon fiber based composite in FIG. 1.

### DETAILED DESCRIPTION

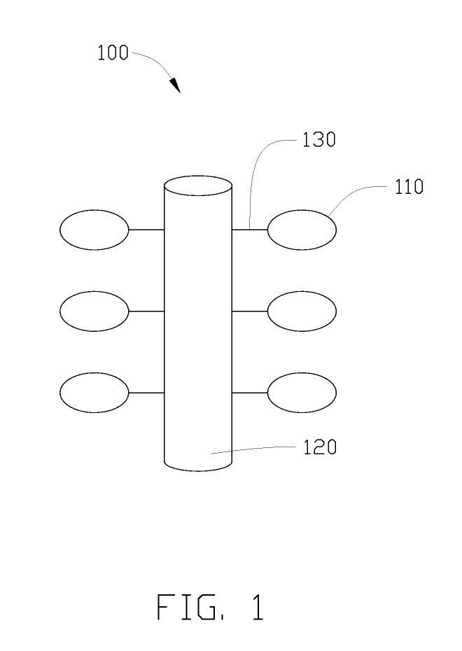

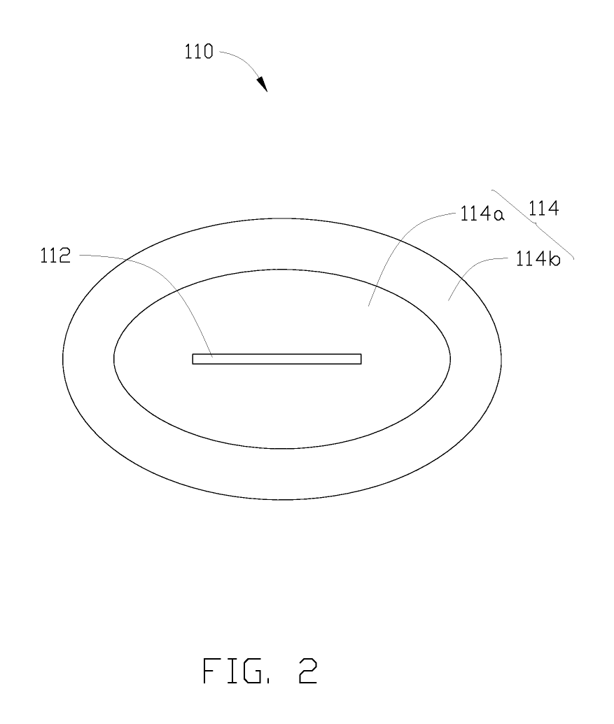

Referring to FIGS. 1 and 2, a composite 100 according to one embodiment includes at least one carbon nanotube microcapsule 110 and a fiber 120. The carbon nanotube microcapsule 110 is grafted to the fiber 120. More specifically, the carbon nanotube microcapsule 110 is joined to a surface of the fiber 120 by at least one chemical bond 130 therebetween. In one embodiment, the chemical bond 130 is a covalent bond.

The carbon nanotube microcapsule 110 includes at least one carbon nanotube 112, and a shell 114. The carbon nanotube 112 is encapsulated within the shell 114.

The carbon nanotube 112 can be selected from single-walled, double-walled, and multi-walled carbon nanotubes 112. More than one carbon nanotube 112 can be encapsulated by the same shell 114, and the carbon nanotubes 112 can be single-walled, double-walled, and/or multi-walled carbon nanotubes 112.

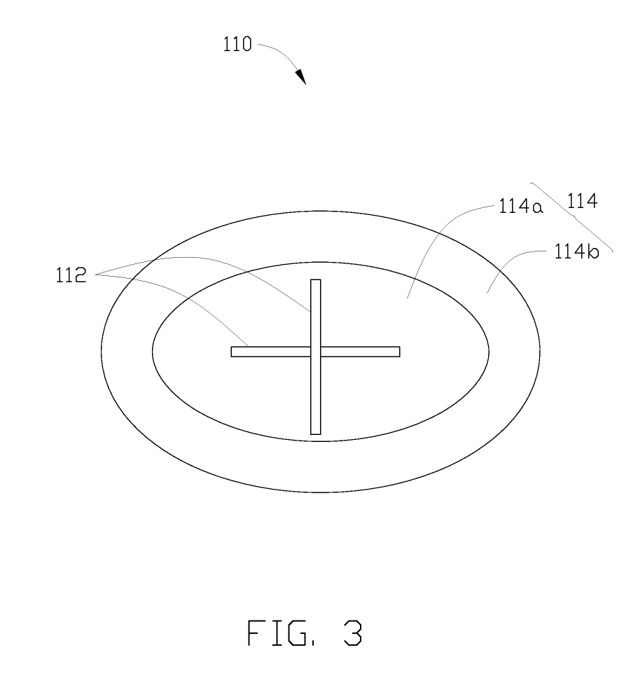

Referring to FIG. 2, an oval carbon nanotube microcapsule 110 can be formed by the shell 114 with a single carbon nanotube 112 encapsulated therein. Referring to FIG. 3, a round carbon nanotube microcapsule 110 can be formed by the shell 114 with several carbon nanotubes 112 encapsulated therein, wherein the carbon nanotubes 112 are aligned along different directions.

The material of the shell 114 is a polymer. In the present embodiment, the shell 114 includes a first shell 114a and a second shell 114b. The first shell 114a directly encapsulates the carbon nanotube 112. The second shell 114b encapsulates the first shell 114a. The material of the first shell 114a can be polyurea resin, melamine-formaldehyde resin, polyurea-formaldehyde resin, or combinations thereof. In the present embodiment, the material of the first shell 114a is polyurea resin. The polyurea resin can be formed from toluene-2,4-diisocyanate (TDI) through an interfacial polymerization reaction. The first shell 114a encapsulates the carbon nanotube 112 to protect the carbon nanotube 112 from being damaged during a process for forming first functional groups on the second shell 114b.

The second shell 114b encapsulates the first shell 114a and combines with the first shell 114a through chemical bonds. The outer surface of the second shell 114b has a plurality of first functional groups capable of reacting with a plurality of second functional groups on the fiber 120, thereby forming the chemical bond 130 to graft the carbon nanotube microcapsule 110 onto the fiber 120. The material of the second shell 114b can be at least one of polymethacrylic acid and poly(glycidyl methacrylate). The first functional groups are active functional groups, and can be at least one of amino group, vinyl group, hydroxyl group, acid anhydride group, epoxy group, aldehyde group, and carboxyl group. In the present embodiment, the material of the second shell 114b is polymethacrylic acid, which is formed from methacrylic acid by a condensation reaction in a sodium persulfate solution, and the first functional groups are carboxyl groups of the polymethacrylic acid.

In other embodiments, the shell 114 may only include the first shell 114a, in which the outer surface of the first shell 114a would have a plurality of first functional groups. In one embodiment, the material of the first shell 114a can be the polymer having the first functional groups. In other embodiments, an additional oxidization treatment of the first shell 114a can be performed to obtain the first functional groups. For example, the first shell 114a made of polyurea resin can be oxidized, and the methyls in the polyurea can be oxidized into carboxyl groups, aldehyde groups, or hydroxyl groups, which can be used as the first functional groups.

The fiber 120 can include a core and a coating coated outside the core. The core can be at least one of carbon fiber, glass fiber, and cellulose fiber. In one embodiment, the carbon fiber can be pitch fiber, polyacrylonitrile fiber, rayon, or phenolic fiber. The coating can include a plurality of second functional groups to bond with the carbon nanotube microcapsule 110. The second functional groups are active functional groups. The material of the coating can be at least one of polyvinyl alcohol, polyvinyl acetate, glycidyl ether, and cycloaliphatic epoxide. In the present embodiment, the core is pitch fiber, the coating is made of polyvinyl alcohol, and the second functional groups are the hydroxyl groups of polyvinyl alcohol. The chemical bonds 130 between the carbon nanotube microcapsule 110 and the fiber 120 is the covalent bonds formed from the carboxyl groups of the carbon nanotube microcapsule 110 and the hydroxyl groups of the fiber 120 by esterification. In the present embodiment, an amount of pitch fibers are disposed into a coating device at a room temperature of about 15° C. to about 35° C., and sprayed by a polyvinyl alcohol spray.

The coating on the core of the fiber 120 is made of a material that has been or can be treated to have the second functional groups. It can be understood that when the fiber 120 only includes the core, a step of treating the core with a mild acid may also obtain the second functional groups. However, the acid should be mild enough to prevent structural damage to the core, thereby preventing deterioration of the mechanical properties of the fiber 120.

The carbon nanotubes 112 are attached to the fiber 120 without any functionalization of the carbon nanotubes 112 themselves, but only forming the chemical bonds 130 between carbon nanotube microcapsules 110 and the fiber 120. Therefore, the intrinsic properties of the carbon nanotubes are preserved.

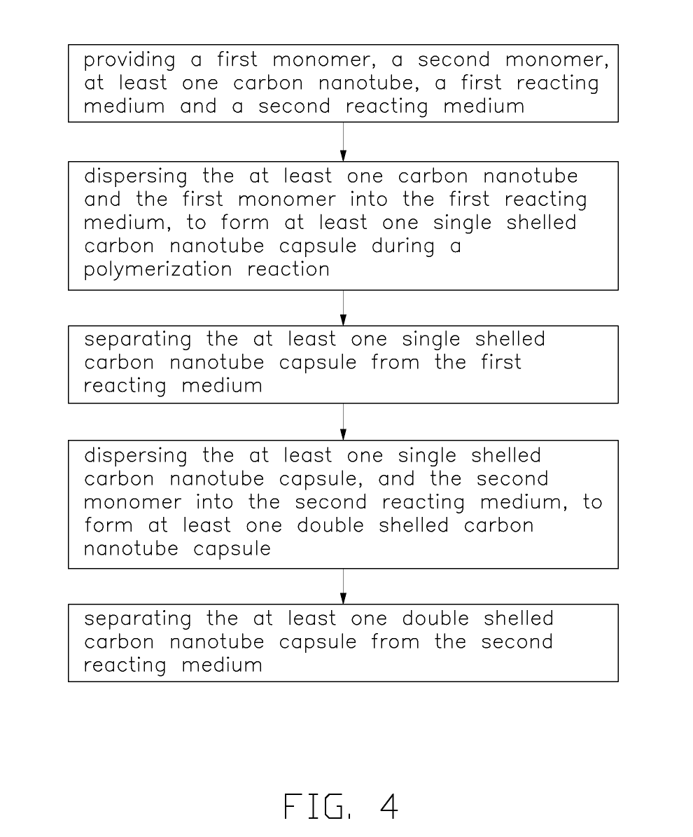

Referring to FIG. 4, a method for making the carbon nanotube microcapsule 110 according to one embodiment includes:

S10: providing a first monomer, a second monomer, at least one carbon nanotube 112, a first reacting medium and a second reacting medium;

S12: dispersing the at least one carbon nanotube 112 and the first monomer into the first reacting medium, to form at least one single shelled carbon nanotube microcapsule 110 during a polymerization reaction;

S14: separating the at least one single shelled carbon nanotube microcapsule 110 from the first reacting medium;

S16: dispersing the at least one single shelled carbon nanotube microcapsule 110 and the second monomer into the second reacting medium, to form at least one double shelled carbon nanotube microcapsule 110; and

S18: separating the at least one double shelled carbon nanotube microcapsule 110 from the second reacting medium.

In the present embodiment, the first monomer is toluene diisocyanate (TDI), and the first reacting medium is a mixture of water, polyvinyl alcohol (PVA), and a catalyst (e.g., dibutyltin dilaurate (DBTDL)). The material of the first shell 114a is polyurea resin. More specifically, an amount of carbon nanotubes 112, water, and PVA are mixed in a container to form a mixture. The mixture is stirred rapidly, while the TDI is mixed with the mixture, and the DBTDL is added into the container at an elevated temperature of about 70° C. to about 85° C. to react for more than 2 hours. After interfacial polymerization reaction, the single shelled carbon nanotube microcapsules 110 can be formed in the first reacting medium.

In step S14, the single shelled carbon nanotube microcapsules 110 can be separated from the first reacting medium by a method including: decreasing the temperature of the first reacting medium to room temperature; aging the mixture of the first reacting medium and the single shelled carbon nanotube microcapsules 110 therein; infiltrating the single shelled carbon nanotube microcapsules 110 from the mixture; washing the single shelled carbon nanotube microcapsules 110 with ethanol; and drying the single shelled carbon nanotube microcapsules 110. The dried single shelled carbon nanotube microcapsules 110 are in a form of white powder.

In step S16, the second shell 114b has the first functional groups on the surface thereof. In the present embodiment, the second monomer is polymethacrylic acid and the second reacting medium is a mixture of water and sodium persulfate. The second monomer is reacted in the second reacting medium at a temperature of about 85° C. to about 95° C. for more than 2 hours to achieve the polymethacrylic acid shell 114b outside the single shelled carbon nanotube microcapsule 110. In the present embodiment, the first functional groups are carboxyl groups.

In step S18, the double shelled carbon nanotube microcapsules 110 can be separated from the second reacting medium by an infiltrating step.

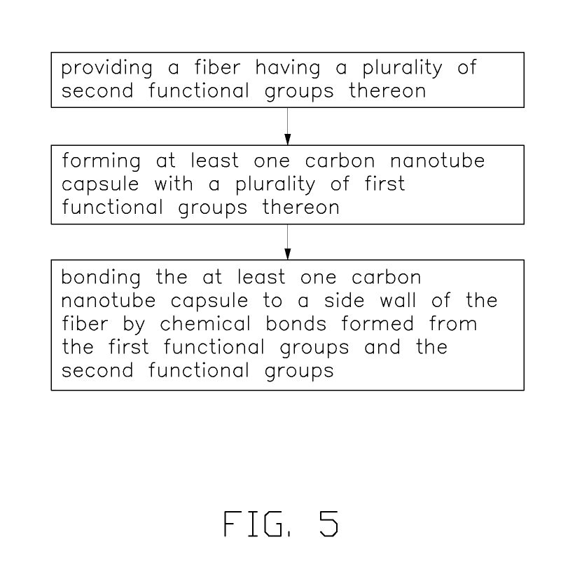

Referring to FIG. 5, a method for making a composite 100, according to one embodiment, includes:

S20 providing a fiber 120 having a plurality of second functional groups thereon;

S22 forming at least one carbon nanotube microcapsule 110 with a plurality of first functional groups thereon, by a method described above; and

S24 bonding the at least one carbon nanotube microcapsule 110 to a sidewall of the fiber 120 by chemical bonds 130 formed from the first functional groups and the second functional groups.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

It is also to be understood that above description and the claims drawn to a method may include some indication in reference to certain steps. However, the indication used is only to be viewed for identification purposes and not as a suggestion as to an order for the steps.

What is claimed is:

1. A carbon nanotube microcapsule comprising:
at least one carbon nanotube; and
a shell encapsulating the at least one carbon nanotube, the shell comprising a plurality of first functional groups.

2. The carbon nanotube microcapsule of claim 1, wherein the material of the shell is a polymer.

3. The carbon nanotube microcapsule of claim 1, wherein the shell further comprises a first shell encapsulating the at least one carbon nanotube; the plurality of first functional groups are located on the first shell.

4. The carbon nanotube microcapsule of claim 1, wherein the shell further comprises a first shell encapsulating the at least one carbon nanotube and a second shell encapsulating the first shell; the plurality of first functional groups are located on the second shell.

5. The carbon nanotube microcapsule of claim 4, wherein the first shell is combined with the second shell by chemical bonds.

6. The carbon nanotube microcapsule of claim 5, wherein a material of the first shell is selected from the group consisting of polyurea resin, melamine-formaldehyde resin, polyurea-formaldehyde resin, and combinations thereof; a material of the second shell is selected from the group consisting of polymethacrylic acid, poly(glycidyl methacrylate), and combinations thereof.

7. The carbon nanotube microcapsule of claim 4, wherein the first functional groups are at least one of an amino group, a vinyl group, a hydroxyl group, an acid anhydride group, an epoxy group, an aldehyde group, and a carboxyl group.

8. The carbon nanotube microcapsule of claim 1, wherein the first functional groups are capable of reacting with functional groups of a fiber to form chemical bonds.

9. A composite comprising:
a fiber; and
at least one carbon nanotube microcapsule grafted on the fiber by a chemical bond, the at least one carbon nanotube microcapsule comprising at least one carbon nanotube and a shell encapsulating the at least one carbon nanotube, the shell comprising a plurality of first functional groups.

10. The composite of claim 9, wherein the material of the shell is a polymer.

11. The composite of claim 9, wherein the fiber comprises a core selected from the group consisting of carbon fiber, glass fiber, and cellulose fiber.

12. The composite of claim 11, wherein the carbon fiber is pitch fiber, polyacrylonitrile fiber, rayon, or phenolic fiber.

13. The composite of claim 9, wherein the fiber comprises a core and a coating coated on the core.

14. The composite of claim 13, wherein a material of the coating is selected from the group consisting of polyvinyl alcohol, polyvinyl acetate, glycidyl ether, cycloaliphatic epoxide, and combinations thereof.

15. A method for making a carbon nanotube microcapsule, the method comprising:
providing a first monomer, a second monomer, at least one carbon nanotube, a first reacting medium, and a second reacting medium;
dispersing the at least one carbon nanotube and the first monomer into the first reacting medium, to form at least one single shelled carbon nanotube microcapsule during a polymerization reaction;
separating the at least one single shelled carbon nanotube microcapsule from the first reacting medium;
dispersing the at least one single shelled carbon nanotube microcapsule and the second monomer into the second reacting medium, to form at least one double shelled carbon nanotube microcapsule; and
separating the at least one double shelled carbon nanotube microcapsule from the second reacting medium.

16. The method of claim 15, wherein the first monomer is toluene-2,4-diisocyanate, and the first reacting medium is a mixture of water, polyvinyl alcohol, and dibutyltin dilaurate.

17. The method of claim 16, wherein the first monomer and the at least one carbon nanotube are mixed in the first reacting medium at an elevated temperature of about 70° C. to about 85° C. to react for more than 2 hours.

18. The method of claim 17, wherein the at least one single shelled carbon nanotube microcapsule is separated from the first reacting medium by:
decreasing the temperature to about 15° C. to about 35° C.;
aging the first reacting medium and the at least one single shelled carbon nanotube microcapsule therein;
infiltrating the at least one single shelled carbon nanotube microcapsule from the first reacting medium;
washing the at least one single shelled carbon nanotube microcapsule with ethanol; and
drying the at least one single shelled carbon nanotube microcapsule.

19. The method of claim 15, wherein the second monomer is polymethacrylic acid, and the second reacting medium is a mixture of water and sodium persulfate.

20. The method of claim 15, wherein the second monomer and the at least one single shelled carbon nanotube microcapsule are reacted in the second reacting medium at a temperature of about 85° C. to about 95° C. for more than 2 hours.
